(19) United States
(12) Patent Application Publication
(10) Pub. No.: US 2013/0133626 A1
(43) Pub. Date: May 30, 2013

(54) CRANKSHAFTLESS INTERNAL COMBUSTION ENGINE

(71) Applicants: Wonjin Jo, Hwaseong-si (KR); Hyunjun Hong, Anyang-si (KR); Youngjic Kim, Yongin-si (KR); Sangmoo Lee, Goyang-si (KR); Jerok Chun, Hwaseong-si (KR)

(72) Inventors: Wonjin Jo, Hwaseong-si (KR); Hyunjun Hong, Anyang-si (KR); Youngjic Kim, Yongin-si (KR); Sangmoo Lee, Goyang-si (KR); Jerok Chun, Hwaseong-si (KR)

(73) Assignee: Hyundai Motor Company, Seoul (KR)

(21) Appl. No.: 13/533,756

(22) Filed: Jun. 26, 2012

(30) Foreign Application Priority Data
Nov. 30, 2011 (KR) 10-2011-0126696

(51) Int. Cl. F02D 15/02

(52) U.S. Cl. 123/48 B

(57) ABSTRACT

A crankshaftless internal combustion engine includes a power shaft unit in which a transferring path of a power system is selected depending on a deactivated state and an activated state of a cylinder and a cylinder separator separating a power system of the deactivated cylinder from the power shaft unit by control of an ECU, thereby improving fuel efficiency due to a uniform change in volume of a combustion chamber of the cylinder and increasing reduction in Nox of exhaust gas, and particularly, a plurality of cylinders are controlled in a variable cylinder scheme to further improve fuel efficiency and be optimal to even EM improvement.

### CROSS-REFERENCE TO RELATED APPLICATIONS

The present application claims priority of Korean Patent Application Number 10-2011-0126696 filed Nov. 30, 2011, the entire contents of which application is incorporated herein for all purposes by this reference.

### BACKGROUND OF INVENTION

1. Field of Invention

The present invention relates to an internal combustion engine, and more particularly, to a crankshaftless internal combustion engine capable of remarkably reducing even noxious exhaust gas while remarkably increasing a fuel efficiency improvement rate by transferring a reciprocating movement of a piston depending on a stroke cycle to power train power or accessory power shaftlessly and variably driving a cylinder.

2. Description of Related Art

In general, in an internal combustion engine such as a gasoline engine or a diesel engine, a piston reciprocates depending on a stroke cycle and the reciprocation movement is converted into rotational toque by using a crankshaft that rotates by receiving the reciprocation.

As described above, rotational force of the crankshaft pulls out engine power and transfers the engine power to a power train or is used as power for driving an accessory such as an electronic apparatus, and as a result, the rotational force serves as a most fundamental component in a power system of the internal combustion engine.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

However, in the crankshaft, a change in a volume in a combustion chamber to a change in a crank angle around a top dead point in a reciprocating stroke cycle of a piston is small, and as a result, high-pressure and high-temperature combustion gas in the combustion chamber cannot but be spilled or heat-transferred to a wall surface of the piston.

The piston operation consequently reduces combustion efficiency to deteriorate fuel efficiency and increase noxious exhaust gas, and as a result, there is a fundamental limit which is not suitable even for high oil prices and strengthened environmental regulations.

However, improvement of the fuel efficiency and reduction of the noxious exhaust gas should be implemented even in the internal combustion engine due to the high oil prices and the strengthened environmental regulations.

As the example, there is a variable cylinder deactivation engine.

In this case, by changing a cylinder driving scheme in which fuel is excessively consumed more than necessary as all the cylinders are simultaneously driven even though all cylinders need not to be driven at a low output, the improvement of the fuel efficiency and the reduction of the noxious exhaust gas can be achieved without changing a configuration of the internal combustion engine.

In general, the crankshaft is necessarily applied even to the variable cylinder deactivation engine having the above engine control scheme.

As a result, heat cannot but be transferred between the high-pressure and high-temperature combustion gas and the piston due to a change in volume in the combustion chamber which is relatively small than the change in crank angle around the top dead point even in the variable cylinder deactivation engine.

Therefore, when the internal combustion engine implements power transfer without the crankshaft which causes heat transfer through the piston and the resulting deterioration in the fuel efficiency, the fuel efficiency can be prevented from deteriorating due to the crankshaft.

Moreover, when the crankshaftless internal combustion engine is cylinder-controlled by a variable cylinder scheme, the fuel efficiency can be further prevented from deteriorating while an increase in the noxious exhaust gas is suppressed.

The maximized prevention of deterioration in the fuel efficiency and the reduction in the noxious exhaust gas can more easily conform to the high oil prices and the strengthened environmental regulations.

However, an aspect of hardware in which the internal combustion engine is configured without the crankshaft and an aspect of software in which the hardware is controlled by the variable cylinder scheme cannot but be complicated due to various factors.

Therefore, the complicated aspects cannot but make it more difficult to commercialize the internal combustion engine capable of controlling the engine by the variable cylinder scheme without the crankshaft.

Various aspects of the present invention provide for a crankshaftless internal combustion engine in which the power of the power train or accessory power transfer is implemented crankshaftlessly with the piston which generates the power by the reciprocating movement which depends on the stroke cycle so as to significantly improve deterioration in the fuel efficiency by removing a bad influence depending on rotating movement of the crankshaft and prevent additional deterioration in the fuel efficiency by variably driving the cylinder according to a vehicle driving condition, thereby significantly increasing a total fuel efficiency improvement rate and significantly reducing the noxious exhaust gas.

Various aspects of the present invention provide for a crankshaftless internal combustion engine, including an engine block constituted by a plurality of cylinders each having reciprocating power systems and controlled in a deactivated state and an activated state, a cylinder head including a valve system for exhausting air as well as supplying fuel required in each cylinder, and an oil pan provided below the cylinder head, a power shaft unit converting power generated from the power system of the activated cylinder into engine output and transferring the engine output to a transmission without transferring the engine output to the power system of the deactivated cylinder, and a cylinder separator controlled by an ECU operating the plurality of cylinders as the deactivated cylinder and the activated cylinder and controlled by the ECU to separate the power system of the deactivated cylinder from the power shaft unit.

The power system of the cylinder may be constituted by a piston reciprocating a combustion chamber of the cylinder to form a 4-stroke cycle and a connecting rod reciprocating together the piston to rotate the power shaft unit.

Vertical reciprocating movement of the connecting rod may be guided by using a pair of first and second gear bosses which engage with a pair of first and second intergears that free rotates in the engine block and rotation of the power shaft unit may use gears formed by different portions where the pair of first and second gear bosses are not formed.

The power shaft unit may be constituted by a main power shaft converting power converted from the connecting rod of the activated cylinder into engine output transferred to the transmission and a sub power shaft preventing the power of the main power shaft from being transferred to the connecting rod of the deactivated cylinder in association with the cylinder separator, while transferring the power converted from the connecting rod of the activated cylinder to the main power shaft.

The main power shaft and the sub power shaft may be arranged horizontally around the connecting rod and rotational force received from the connecting rod may be generated in a unidirectional stroke in a reciprocating stroke of the connecting rod.

Each of the main power shaft and the sub power shaft may include semigears and the semigears may receive the rotational force through the gear of the connecting rod that engages with the semigears.

The main power shaft and the sub power shaft may be connected to a reduction gear in which the plurality of gears are arranged in series, and the reduction gear may be constituted by an input gear connected to the sub power shaft, an output gear connected to the main power shaft, and a switching gear that engages with the input gear and engages with the output gear.

The main power shaft may have a flywheel at a connection portion of the transmission and an accessory configured by a timing gear together with a driving pulley of an electronic apparatus at an opposite side to the connection portion of the transmission.

The cylinder separator may include a moving fork of which the direction is switched to a switching power unit having a relay switched by control by the ECU, and a moving gear that engages with the moving fork, moves on the sub power shaft adding the engine output to the main power shaft of the power shaft unit transferring the engine output to the transmission, and moves the semigears of the sub power shaft of the main power shaft and the sub power shaft each having the semigears that engage with the gear of the connecting rod.

The moving fork may have a fork structure and the moving gear may be configured by a hub with a protruding portion that engages with the fork.

The hub may be spline-coupled to the sub power shaft to move the semigears.

The pair of hubs may be configured to move at least two semigears by one-time movement and the pair of forks moving the hubs may be configured.

According to various aspects of the present invention, deterioration in fuel efficiency may be significantly improved as a bad influence is removed depending on rotating movement of a crankshaft without the crankshaft while using a reciprocating movement of a piston of an internal combustion engine, the deterioration in the fuel efficiency may be further improved due to variable driving of a cylinder according to a vehicle driving condition, and a total fuel efficiency improvement rate of an engine may be significantly increased due to improvement of maximized fuel efficiency deterioration.

Further, a small volume change in a volume of a combustion chamber which is a bad influence due to a change in a crank angle at top dead points of the crankshaft and heat transfer of the piston depending on high temperature and high pressure may be fundamentally prevented to significantly reduce noxious exhaust gas due to an increased Nox generation suppressing rate, and particularly, a fuel efficiency improvement rate may be further increased by preventing heat-transfer loss.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of an exemplary crankshaftless internal combustion engine according to the present invention.

FIG. 2 is a diagram showing a change in volume of an exemplary combustion chamber when a stroke of the crankshaftless internal combustion engine according to the present invention is changed.

FIG. 3 is a diagram showing a detailed configuration of a cylinder power system of an engine block of FIG. 1.

FIG. 4 is a diagram showing a detailed configuration of a power shaft unit and a cylinder separator of FIG. 1.

FIG. 5 is a diagram showing a high-output operating state of an exemplary crankshaftless internal combustion engine according to the present invention.

FIG. 6 is a diagram showing a low-output operating state of an exemplary crankshaftless internal combustion engine according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

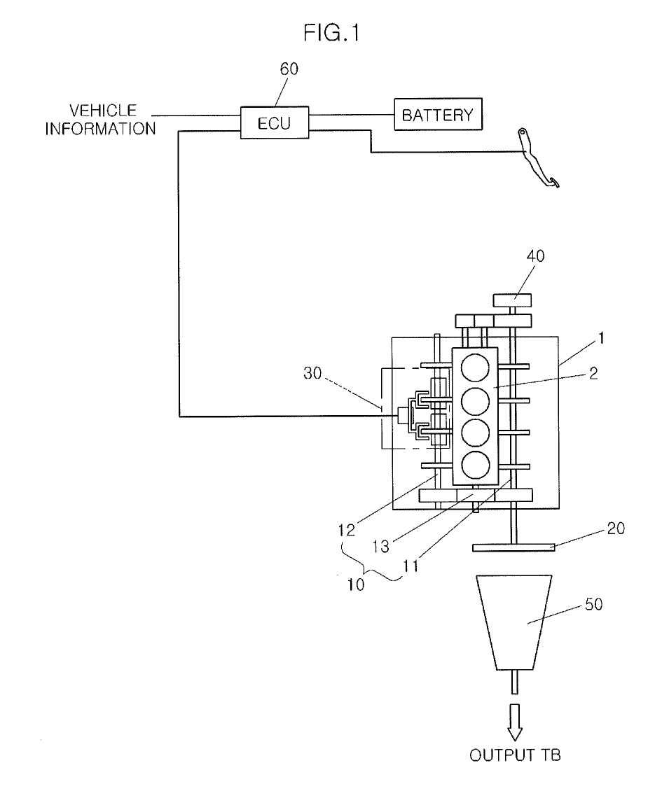

Referring to FIG. 1, a crankshaftless internal combustion engine includes an engine block 1 having a cylinder 2 constituted by at least 4 cylinders or more, a power shaft unit 10 receiving power generated by driving cylinder 2 and converting the received power into an engine output, a cylinder separator 30 disconnecting some deactivated cylinders among cylinders of cylinder 2 or connecting some activated cylinders, a transmission 50 receiving output torque of output shaft unit 10, and an ECU 60 processing various vehicle information including an acceleration pedal and controlling cylinder separator 30 according to the cylinders in the deactivated state and the activated state.

Engine block 1 further includes a cylinder head including a valve system for fuel supplying and combustion exhaustion for each cylinder of cylinder 2.

Power shaft unit 10 includes a main power shaft 11 converting power converted from a power system of the activated cylinder of cylinder 2 into the engine output transferred to transmission 50 and a sub power shaft 12 applying the power converted from the power system of the activated cylinder to main power shaft 11 as well as being associated with cylinder separator 30 so as to interrupt the power of main power shaft 11 transferred from the power system of the deactivated cylinder of cylinder 2.

Main power shaft 11 and sub power shaft 12 are connected to a reduction gear 13 constituted by a plurality of gears.

A flywheel 20 is coupled to main power shaft 11 side connected to transmission 50, while an accessory 40 is coupled to an opposite side to flywheel 20.

A timing gear is provided in accessory 40 together with a pulley for driving an electronic apparatus.

ECU 60 includes a cylinder control logic that makes each cylinder of cylinder 2 in the activated state or the deactivated state and performs the resulting control and the cylinder control logic may be applied in the same manner as a control logic implemented in a variable cylinder engine.

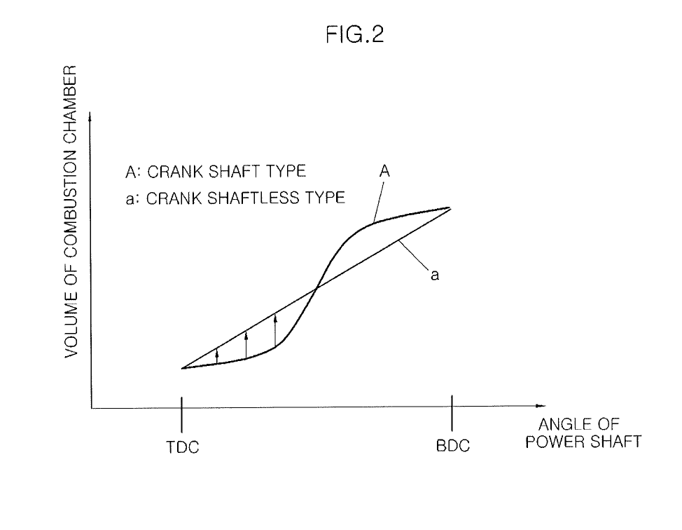

Referring to FIG. 2, a line A represents a change in volume of a cylinder chamber by a piston in a power system having a crankshaft, while a line a represents the change in volume of the combustion chamber by the piston when a variable compression ratio is implemented in a power system having main power shaft 11 and sub power shaft 12 without the crankshaft, as in the present exemplary embodiment.

Between a TDC and a BDC which are angle changes of the main power shaft (alternatively, crankshaft) depending on the stroke cycle, it can be seen that the line A causes the change in volume of the combustion chamber, while the line a uniformly maintains the change in volume of the combustion chamber.

In the case of the line a, fuel efficiency is improved as a holding time of high-temperature and high-pressure states in the combustion chamber is shortened to increase thermal efficiency, and as a result, the fuel efficiency is improved and further, Nox generally generated in the high-temperature state even in exhaust gas is decreased.

In particular, the advantage of the line a is implemented in the engine according to various embodiments and the engine is controlled in the variable cylinder scheme to be described below, thereby making it possible to further improve the fuel efficiency and to be optimal to even EM improvement.

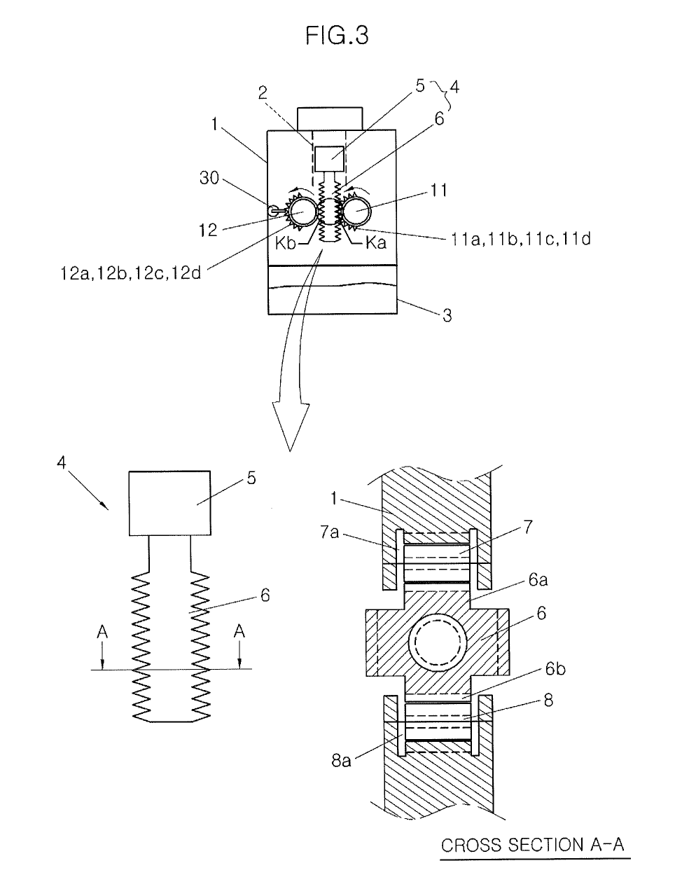

Referring to FIG. 3, an oil pan 3 containing oil is installed in a lower part of engine block 1 and a piston unit 4 configuring the power system of cylinder 2 is provided in engine block 1.

The piston unit 4 includes a piston 5 in which a 4-stroke cycle is formed through reciprocating movement, a connecting rod 6 reciprocating vertically by receiving the movement of piston 5, a moving guider guiding vertical reciprocation of connecting rod 6, and a transfer converting the vertical reciprocation of connecting rod 6 into the engine output.

Referring to a cross section A-A of FIG. 3, the moving guider includes a pair of first and second gear bosses 6a and 6b that protrude on both sides on connecting rod 6 and a pair of first and second intergears 7 and 8 installed in engine block 1 to be freely rotated.

First gear boss 6a engages with first intergear 7 and second gear boss 6b engages with second intergear 8, and the pair of first and second intergears 7 and 8 are installed on dent surfaces 7a and 8a dug in engine block 1, respectively.

The transfer is configured by a gear formed as an outer peripheral surface of connecting rod 6 and power shaft unit 10 engages with connecting rod 6.

Therefore, the vertical reciprocating movement of connecting rod 6 is converted into the rotational torque of power shaft unit 10 and the rotational torque of power shaft unit 10 is provided as the engine output.

Main power shaft 11 of power shaft unit 10 includes semigears 11a, 11b, 11c, and 11d, sub power shaft 12 of power shaft unit 10 includes semigears 12a, 12b, 12c, and 12d, and the number of semigears 11a, 11b, 11c, 11d, 12a, 12b, 12c, and 12d coincides with the number of cylinder 2.

In power shaft unit 10, main power shaft 11 engages with the gear at one side of connecting rod 6 and sub power shaft 12 engages with the gear at the opposite side thereto.

Therefore, layouts of main power shaft 11 and sub power shaft 12 are symmetric to each other around connecting rod 6.

The pair of first and second gear bosses 6a and 6b constituting the moving guider are opposed to each other, and as a result, connecting rod 6 has a “+” cross-sectional shape.

As a result, the gear formed on connecting rod 6 to configure the transfer is formed by two different portions which do not form first and second gear bosses 6a and 6b and the two different portions are opposed to each other.

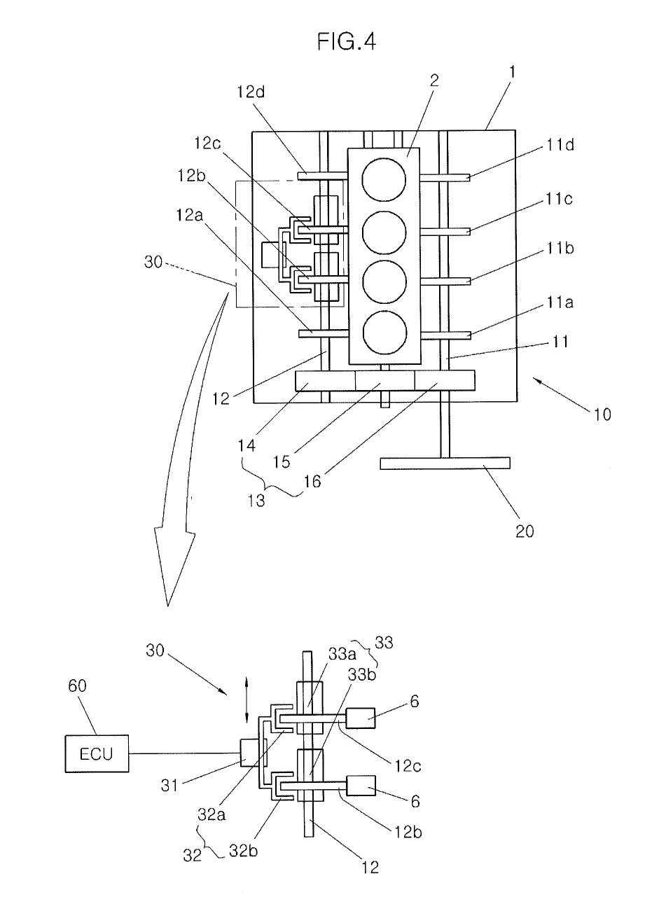

Meanwhile, referring to FIG. 4, power shaft unit 10 forms a layout in which main power shaft 11 is disposed at one side of cylinder 2 and sub power shaft 12 is disposed at an opposite side thereto, and main power shaft 11 and sub power shaft 12 are connected to reduction gear 13 constituted by the plurality of gears.

The plurality of semigears in which the gear is formed at an only half portion of a diameter thereof to engage (Ka) with the gear of connecting rod 6 are provided on main power shaft 11 and the semigears are constituted by 4 semigears 11a, 11b, 11c, and 11d to match 4 cylinders of cylinder 2.

The plurality of semigears in which the gear is formed at an only half portion of a diameter thereof to engage (Kb) with the gear of connecting rod 6 are provided on sub power shaft 12 and the semigears are constituted by 4 semigears 12a, 12b, 12c, and 12d to match 4 cylinders of cylinder 2.

Reduction gear 13 is constituted by an input gear 14 connected to sub power shaft 12 to rotate directly through sub power shaft 12, an output gear 16 connected to main power shaft 11 to apply the rotational force of sub power shaft 12 to main power shaft 11, and a switching gear 15 that engages with input gear 14 and engages with output gear 16.

Input gear 14, switching gear 15, and output gear 16 engage with each other linearly to form a layout arranged linearly.

A gear ratio of input gear 14, switching gear 15, and output gear 16 is determined depending on an engine specification.

Cylinder separator 30 is constituted by a switching power unit 31 having a relay switched by the control of ECU 50, a moving fork 32 of which bidirectional movements are changed depending on a switching direction of switching power unit 31, and a moving gear 33 that engages with moving fork 32 to move together in a movement direction of moving fork 32.

Moving fork 32 is constituted by a pair of first and second forks 32a and 32b that move together in the same direction as the switching direction of switching power unit 31.

A power means that is driven with a power supply which is electrically conducted when switching power unit 31 is switched to move moving fork 32 may be provided between moving fork 32 and switching power unit 31.

The power means is constituted by a motor and a ball screw for converting rotational force of the motor into linear movement or may adopt a means such as a clutch that moves moving fork 32 with the power supply which is electrically conducted when switching power unit 31 is switched.

Moving gear 33 is also constituted by a pair of first and second hubs 33a and 33b.

First and second hubs 33a and 33b engage with first and second forks 32a and 32b of moving fork 32, respectively, and to this end, protruding portions that are coupled with fork structures of first and second forks 32a and 32b to receive force are formed at first and second hubs 33a and 33b.

First and second hubs 33a and 33b move some semigears among semigears 12a, 12b, 12c, and 12d of sub power shaft 12 in a shaft direction of sub power shaft 12 to serve to separate the semigears that moves in the movement direction and the deactivated cylinder side from each other.

For example, first and second hubs 33a and 33b may be configured such that first hub 33a moves second semigear 12b which is one of semigears 12a, 12b, 12c, and 12d and second hub 33b moves third semigear 12c which is another one among semigears 12a, 12b, 12c, and 12d.

First hub 33a and second hub 33b determine exact positions of second semigear 12b and third semigear 12c with respect to the corresponding connecting rods, respectively, and may serve as positioners through the function.

By this configuration, cylinder separator 30 may separate the power systems of the second cylinder and the third cylinder and a power transferring path of power shaft unit 10 form each other when the second cylinder and the third cylinder among 4 cylinders are at a low output which is a deactivation state and unnecessary waste of the engine output is reduced due to separation of the power transferring path, thereby contributing to improving the fuel efficiency.

Actually, the deactivated cylinder and the activated cylinder for each cylinder of cylinder 2 may be changed appropriately according to the number of the cylinders.

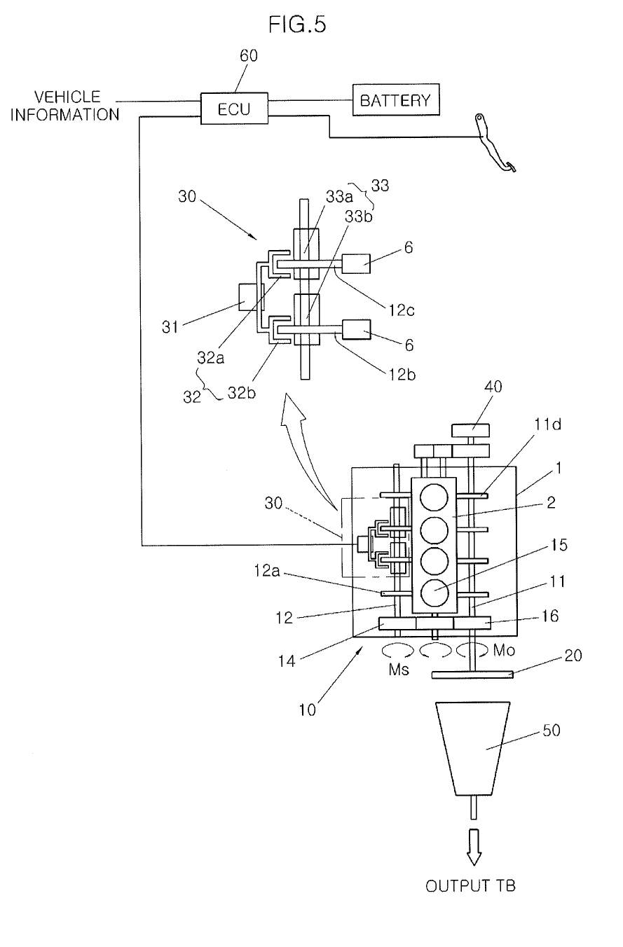

Meanwhile, referring to FIG. 5, in the high-output operation of the engine, all the cylinders of cylinder 2 are simultaneously activated and all the power systems for each cylinder which are being activated and main power shaft 11 and sub power shaft 12 of power shaft unit 10 are connected to each other due to non-operation of cylinder separator 30.

In this state, an engine output Tb is generated through the vertical reciprocating movement of connecting rod 6 which occurs together with piston 5 which is the power system for each cylinder and rotations of connecting rods 6 of main power shaft 11 and sub power shaft 12 positioned at both sides of connecting rod 6.

As described above, the vertical reciprocating movement of connecting rod 6 is stably guided through free rotations of first and second intergears 7 and 8 which engage with first and second gear bosses 6a and 6b of connecting rod 6.

In this case, although main power shaft 11 and sub power shaft 12 generating engine output Tb are rotated by vertical movement of connecting rod 6 at both sides of connecting rod 6, main power shaft 11 and sub power shaft 12 rotate only in one direction.

The reason is because a gear forming section of semigears 11a, 11b, 11c, and 11d of main power shaft 11 and semigears 12a, 12b, 12c, and 12d of sub power shaft 12 is formed according to a downward stroke length of connecting rod 6 which descends together with piston 5 in an explosion stroke.

For example, referring to FIG. 3, when a stroke to drop connecting rod 6 together with piston 5 occurs as the explosion stroke of the cylinder, semigears 11a, 11b, 11c, and 11d of main power shaft 11 and semigears 12a, 12b, 12c, and 12d of sub power shaft 12 engage (Ka and Kb) with the gear of connecting rod 6 such that the semigears rotate.

On the contrary, when a stroke to lift connecting rod 6 together with piston 5 occurs as a suction stroke, semigears 11a, 11b, 11c, and 11d of main power shaft 11 and semigears 12a, 12b, 12c, and 12d of sub power shaft 12 do not engage with the gear of connecting rod 6.

Therefore, the engine is in a high-output state when cylinder separator 30 is not operated and engine output Tb is expressed as rotational force Mo of main power shaft 11 receiving rotational force Ms of sub power shaft 12 transferred through reduction gear 13 together.

This means that main power shaft 11 uses the powers of all the activated cylinders as engine output Tb to activate the engine in the high-output state.

Engine output Tb outputted from main power shaft 11 is transferred to transmission 50 and transmission 50 is shifted to an appropriate shift step according to a driver's control or the control of ECU 60, such that a vehicle may be driven in the high-output state.

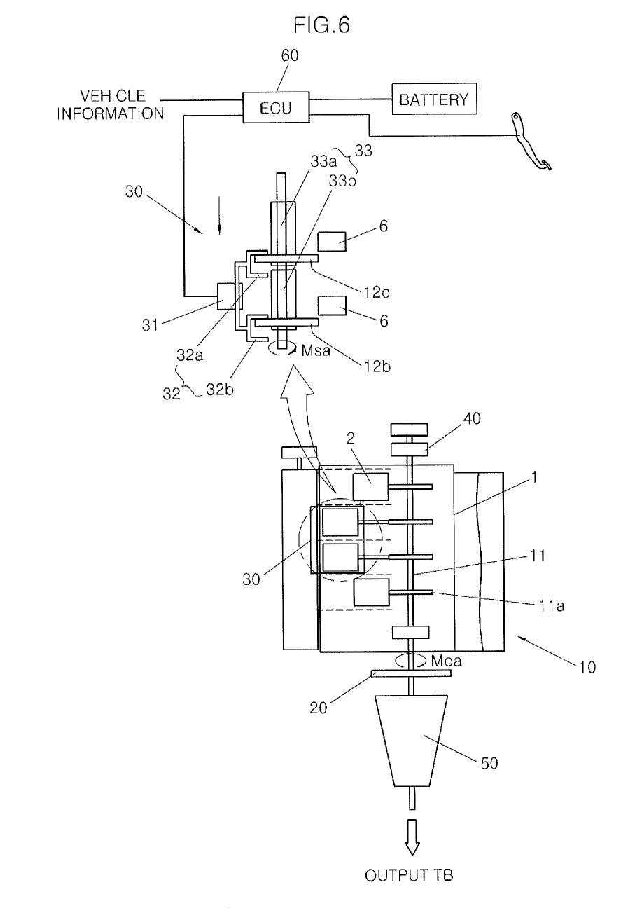

On the contrary, FIG. 6 shows a low-output operating state of the engine. When the engine operates in low output, the first cylinder and the fourth cylinder among the 4 cylinders of cylinder 2 are activated, while the second cylinder and the third cylinder are deactivated.

This is performed by the cylinder control logic of ECU 60.

In this case, cylinder separator 30 is controlled by ECU 60 to separate the power systems of the second cylinder and the third cylinder that are deactivated.

Therefore, the power systems of the first cylinder and the fourth cylinder that are activated and the power transferring path of power shaft unit 10 are connected to each other to be switched to an engine output Ta, while the power systems of the second cylinder and the third cylinder that are deactivated and the power transferring path of power shaft unit 10 are switched to a separated state.

When the power systems of the second cylinder and the third cylinder and the power transferring path of power shaft unit 10 are separated from each other, rotational force of power shaft unit 10 through the first cylinder and the fourth cylinder that are activated is not used to operate the power systems (piston and connecting rod) of the second cylinder and the third cylinder that are deactivated, and as a result, engine output Ta is also prevented from deteriorating to improve the fuel efficiency.

However, when cylinder separator 30 is operated by ECU 60, the pair of first and second forks 32a and 32b are moved by switching power unit 31 in which power is electrically conducted.

Then, the pair of first and second hubs 33a and 33b that engage with first and second forks 32a and 32b are moved together with first and second forks 32a and 32b by taking a spline of sub power shaft 12, such that second and third semigears 12b and 12c of sub power shaft 12 also move.

As a result, second semigear 12b is separated from the connecting rod configuring the power system of the second cylinder and the third semigear 12c is separated from the connecting rod configuring the power system of the third cylinder.

In this state, when ECU 60 operates the pair of first and second forks 32a and 32b in a reverse direction, the second and third semigears 12b and 12c are connected with the connecting rods again.

When the engine is in the low-output state, engine output Ta is generated by rotational force Moa of main power shaft 11 receiving rotational force Msa of sub power shaft 12 transferred through reduction gear 13 together.

When the engine is in the low-output state, efficiency in which rotational force Moa of main power shaft 11 is used as engine output Tb is significantly increased, and as a result, engine output Ta is prevented from deteriorating and the fuel efficiency can be improved.

As described above, the crankshaftless internal combustion engine according to various embodiments includes a power shaft unit 10 in which a transferring path of a power system is selected depending on a deactivated state and an activated state of a cylinder and a cylinder separator 30 separating a power system of the deactivated cylinder from power shaft unit 10 by control of an ECU 60, thereby improving fuel efficiency due to a uniform change in volume of a combustion chamber of the cylinder and increasing reduction in Nox of exhaust gas, and particularly, a plurality of cylinders are controlled in a variable cylinder scheme to further improve fuel efficiency and be optimal to even EM improvement.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A crankshaftless internal combustion engine comprising:
an engine block including a plurality of cylinders each having reciprocating power systems and controlled in a deactivated state and an activated state;
a cylinder head including a valve system for exhausting air from and supplying fuel to each of said cylinders;
an oil pan provided below the cylinder head;
a power shaft unit converting power generated from an associated power system of an activated one of said cylinders into engine output and transferring the engine output to a transmission without transferring the engine output to the power system of any deactivated ones of said cylinders; and
a cylinder separator controlled by an ECU operating the plurality of cylinders in respective deactivated and activated states, wherein the cylinder separator is controlled by the ECU to separate the respective power systems of any deactivated ones of said cylinders from the power shaft unit.

2. The crankshaftless internal combustion engine as defined in claim 1, wherein each power system includes a piston reciprocating a combustion chamber of the cylinder to form a 4-stroke cycle and a connecting rod reciprocating with the piston to rotate the power shaft unit.

3. The crankshaftless internal combustion engine as defined in claim 2, wherein vertical reciprocating movement of the connecting rod is guided by a pair of first and second gear bosses which engage with a pair of first and second intergears that freely rotate in the engine block, and rotation of the power shaft unit uses gears formed by different portions where the pair of first and second gear bosses are not formed.

4. The crankshaftless internal combustion engine as defined in claim 3, wherein each power shaft unit includes a main power shaft converting power converted from the connecting rod of the activated cylinder into engine output transferred to the transmission and a sub power shaft preventing the power of the main power shaft from being transferred to the connecting rod of the deactivated cylinder in association with the cylinder separator, while transferring the power converted from the connecting rod of the activated cylinder to the main power shaft.

5. The crankshaftless internal combustion engine as defined in claim 4, wherein the main power shaft and the sub power shaft are arranged horizontally around the connecting rod and rotational force received from the connecting rod is generated in a unidirectional stroke in a reciprocating stroke of the connecting rod.

6. The crankshaftless internal combustion engine as defined in claim 5, wherein each of the main power shaft and the sub power shaft includes semigears and the semigears receive the rotational force through the gear of the connecting rod that engages with the semigears.

7. The crankshaftless internal combustion engine as defined in claim 4, wherein the main power shaft and the sub power shaft are connected to a reduction gear in which the plurality of gears are arranged in series, and the reduction gear is constituted by an input gear connected to the sub power shaft, an output gear connected to the main power shaft, and a switching gear that engages with the input gear and engages with the output gear.

8. The crankshaftless internal combustion engine as defined in claim 4, wherein the main power shaft has a flywheel at a connection portion of the transmission and an accessory configured by a timing gear together with a driving pulley of an electronic apparatus at an opposite side to the connection portion of the transmission.

9. The crankshaftless internal combustion engine as defined in claim 1, wherein the cylinder separator includes:
a moving fork of which the direction is switched to a switching power unit having a relay switched by control by the ECU; and
a moving gear that engages with the moving fork, moves on the sub power shaft adding the engine output to the main power shaft of the power shaft unit transferring the engine output to the transmission, and moves the semigears of the sub power shaft of the main power shaft and the sub power shaft each having the semigears that engage with the gear of the connecting rod.

10. The crankshaftless internal combustion engine as defined in claim 9, wherein the moving fork has a fork structure and the moving gear is configured by a hub with a protruding portion that engages with the fork.

11. The crankshaftless internal combustion engine as defined in claim 9, wherein the hub is spline-coupled to the sub power shaft to move the semigears.

12. The crankshaftless internal combustion engine as defined in claim 9, wherein the pair of hubs are configured to move at least two semigears by one-time movement and the pair of forks moving the hubs are configured.

13. The crankshaftless internal combustion engine as defined in claim 10, wherein the pair of hubs are configured to move at least two semigears by one-time movement and the pair of forks moving the hubs are configured.

14. The crankshaftless internal combustion engine as defined in claim 11, wherein the pair of hubs are configured to move at least two semigears by one-time movement and the pair of forks moving the hubs are configured.
